(19) United States
(12) Patent Application Publication
(10) Pub. No.: US 2019/0187811 A1
(43) Pub. Date: Jun. 20, 2019

(54) GRAFFITI WALL VIRTUAL REALITY SYSTEM AND METHOD

(71) Applicant: The Spark Agency, Inc., St. Louis, MO (US)

(72) Inventors: Jacob M. Hawkins, O'Fallon, MO (US); Marcus Griffen, St. Louis, MO (US)

(73) Assignee: The Spark Agency, Inc., St. Louis, MO (US)

(21) Appl. No.: 16/223,754

(22) Filed: Dec. 18, 2018

Related U.S. Application Data
(60) Provisional application No. 62/607,212, filed on Dec. 18, 2017.

(51) Int. Cl. G06F 3/03; G06F 3/0346; G06T 11/00

(52) U.S. Cl. CPC G06F 3/0308; G09G 3/32; G06T 11/001; G06F 3/0346

(57) ABSTRACT

A virtual reality graffiti wall system comprising an image display, a housing simulating a spray paint can, and a position tracker attached to the housing. The position tracker generates positioning data representative of its position as well as a spray signal in response to user input. A plurality of sensors determines the position of the position tracker relative to the image display based on the positioning data. A computing device causes the image display to display an image representative of a virtual spray of paint on the image display corresponding to the determined position in response to the spray signal.

### CROSS-REFERENCE TO RELATED APPLICATION

The present application claims the benefit of U.S. Provisional Application No. 62/607,212, filed Dec. 18, 2017, the entirety of which is hereby incorporated by reference.

### BACKGROUND

Traditionally, virtual reality has been a one-person experience that essentially takes place inside an individual user's headset using a conventional virtual reality system, such as an HTC VIVE system available from HTC Corporation, an Oculus Rift available from Oculus VR, LLC, or the like. A problem with these types of experiences is that they happen alone, and it is difficult for the audience to see what the user sees or experience what the user experiences.

A system using virtual reality technology to create a shared experience for a large group is desired so many people can watch, experience, and enjoy at the same time as the user.

### SUMMARY

Aspects of the present disclosure allow users to “paint” and design large objects on an LED wall or other large monitor or screen using a virtual reality platform. In operation, a user appears to paint on the LED wall with a simulated spray paint can. The can comprises a motion tracking position detector, or tracker, configured to be compatible with the virtual reality platform. The system permits the user to virtually paint on the LED wall without wearing a headset. And it allows an audience to see what is being created on the screen in real time.

In an aspect, a virtual reality graffiti wall system comprises an image display, a housing simulating a spray paint can, and a position tracker attached to the housing. The position tracker generates positioning data representative of its position as well as a spray signal in response to user input. A plurality of sensors determines the position of the position tracker relative to the image display based on the positioning data. A computing device causes the image display to display an image representative of a virtual spray of paint on the image display corresponding to the determined position in response to the spray signal.

Other objects and features will be in part apparent and in part pointed out hereinafter.

### BRIEF DESCRIPTION OF THE DRAWINGS

FIG. 1 is a block diagram illustrating components of a virtual reality system according to an embodiment.

FIG. 2 is a perspective view of a spray can body for use in the system of FIG. 1.

FIG. 3 illustrates an exemplary operational flow according to an embodiment.

FIG. 4 is a block diagram illustrating further aspects of the system of FIG. 2.

Corresponding reference characters indicate corresponding parts throughout the drawings.

### DETAILED DESCRIPTION

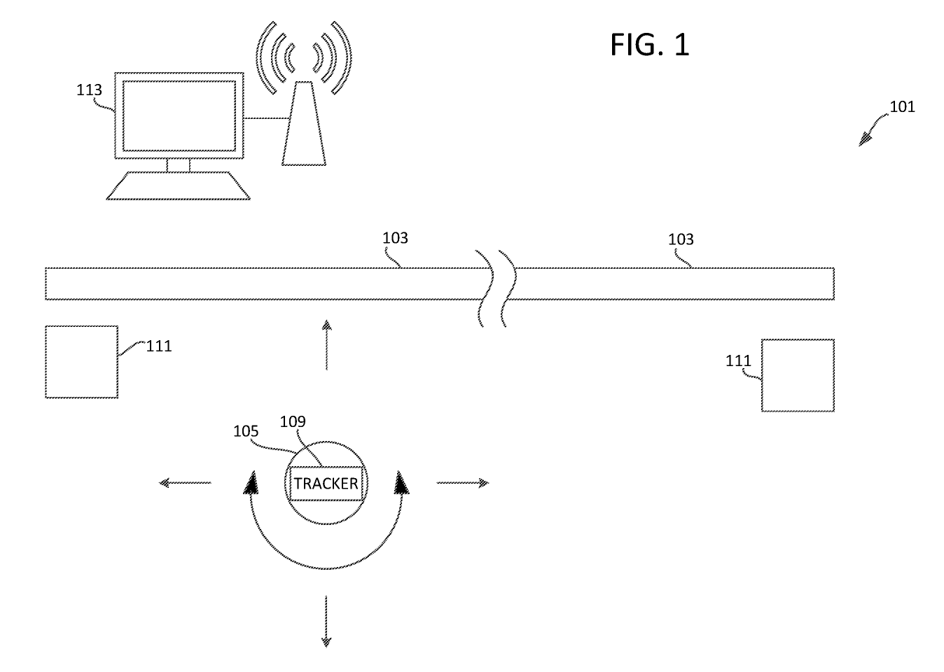

Referring to FIG. 1, a virtual reality system 101 embodying aspects of the present disclosure is shown. The system 101 allows users to paint and design large objects on an LED wall 103 or other large monitor or screen using a virtual reality platform. In operation, a user appears to paint on the LED wall 103 using a simulated spray paint can 105. The can 105 comprises a motion tracking position detector, or tracker, 109 configured to be compatible with the virtual reality platform. In an embodiment, the position tracker 109 is a VIVE Tracker available from HTC Corporation. The system 101 permits the user to virtually paint on the LED wall 103 without wearing a headset. Moreover, the system allows an audience to see what is being created on the screen in real time.

As shown in FIG. 1, system 101 embodying aspects of the invention includes virtual reality base stations, or sensors, 111 such as Vive base stations available from HTC, for tracking the movement (positions and rotations) of the position tracker 109 relative to the wall 103. In an embodiment, an array of LEDs inside each sensor 111 flashes many times per second, and a laser sweeps a beam of light across the room. The sensors 111 transmit non-visible light into the 3D space in front of wall 103.

In an embodiment, system 101 is operable to provide position and identification information concerning a physical object, in this instant an input device such as spray paint can body 105 fitted with position tracker 109. The sensors 111 provide a real time stream of position information (e.g., video, position x,y,z coordinates and movement vectors, and/or any other type of position information that is updated in real time). Moreover, the system of sensors 111 and tracker 109 may include one or more of a: camera system; a magnetic field based system; capacitive sensors; radar; acoustic; other suitable sensor configuration, optical, radio, magnetic, and inertial technologies, such as lighthouses, ultrasonic, IR/LEDs, slam tracking, lidar tracking, ultra-wideband tracking, and other suitable technologies as understood to one skilled in the art.

As described above, position tracker 109 takes the form of spray paint can 105. In the illustrated embodiment, wall 103 comprises an image display such as an LED wall or screen. The information collected from sensors 111 and position tracker 109 are then relayed to a computer 113 coupled to wall 103. In operation, the computer 113 executes a program to analyze the sensor and position data to cause the appropriate information to be displayed on the LED screen/wall 103. The computer 113 executes instructions stored in memory that cause the position tracker 109 to continuously measure its position and orientation using the sensors 111. Inasmuch as sensors 111 relative to themselves, they also detect the position and rotation of spray can 105 (including tracker 109) relative to wall 103. The sensors 111 broadcast the position and orientation data over a short range wireless connection to computer 113 according to the illustrated embodiment of FIG. 1. It is to be understood that system 101 may include more than one spray can 105. For instance, the sensors 111 of system 101 are configured to obtain position data from a plurality of position trackers 109, each coupled to a spray can body 105, and computer 113 is likewise configured to cause wall 103 to display virtual spray painting corresponding to each of the spray cans 105.

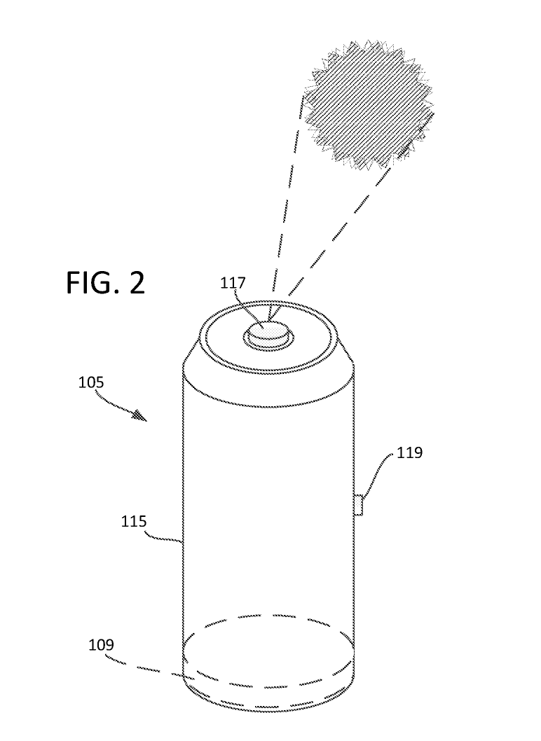

FIG. 2 is a perspective view of spray can 105 according to an embodiment. The can 105 comprises a housing 115 manufactured to simulate the size and shape of a typical can of spray paint. In an embodiment, the housing 115 is manufactured using a 3D printing process. The housing 115 includes a condition input sensor for receiving user input and generating a condition input data in response. The position tracker 109 is attached to housing 115 and connected to custom components and wires inside the can during assembly. The can bottom is configured to fit over an upside-down position tracker such that the Pogo pin and micro USB connector are accessible within the interior of housing 115. The position tracker 109 is responsive to the condition input data for generating the spray signal. The condition input sensor comprises at least one of a pressure sensor, a button trigger, a touch sensor, and a motion sensor, or the like, such as a nozzle (button) 117.

Referring further to FIG. 2, a user presses the nozzle (button) 117 to begin spraying, and releases the nozzle (button) 117 to finish spraying. The user presses and holds a button 119 on the side of the housing 115 to bring up a color selector on the LED screen 103. The color selector is, for example, a wheel of different colors displayed on the wall 103 with an arrow, cursor, highlighter, marker, or other displayed indicator that moves along the color wheel at the user's direction by moving the can 105. The user holds the marker over the color he or she wants, which highlights the desired color, and releases the color selector button 119 to select the highlighted color.

In an embodiment, wall 103 displays the virtual spray over a background image or wallpaper. For example, the wall 103 displays an image of a brick pattern simulating a brick wall and superimposes the virtual spray paint on the brick pattern similar to actual graffiti.

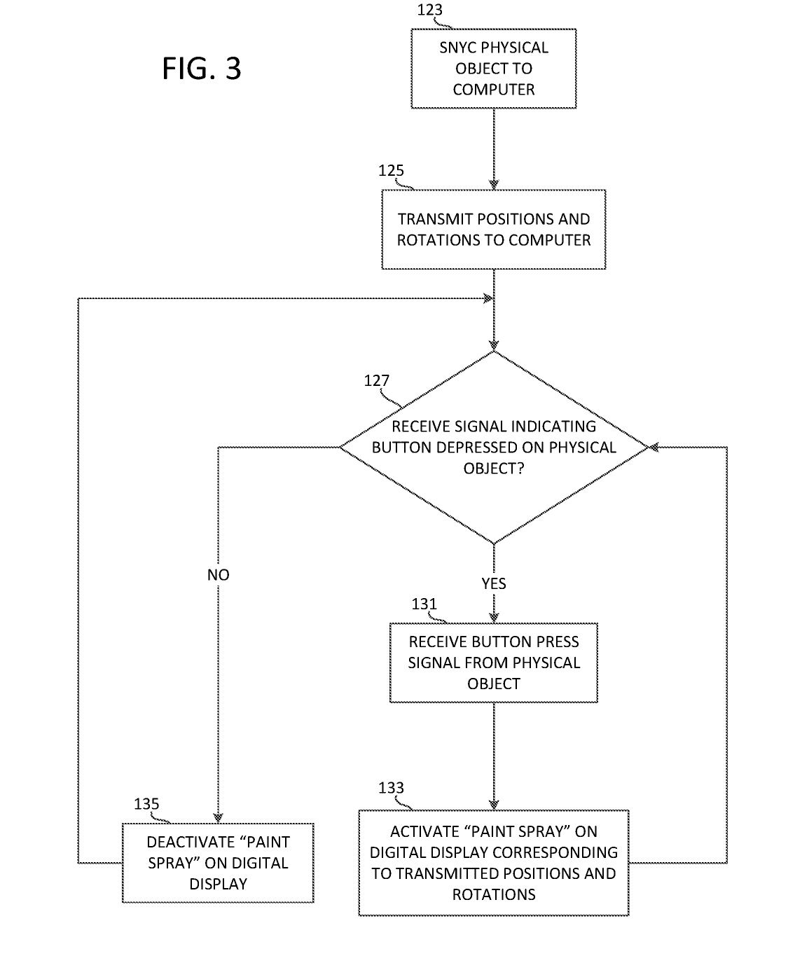

Referring now to FIG. 3, when the user holds the physical object, i.e., the spray can 105 having tracker 109, up to the screen 103, the system 101 syncs the object to a virtual reality compatible computer, such as computer 113 of FIG. 1, at 123. At 125, the tracker 109 transfers the relative positions of the spray can 105 (via the tracker 109) and the screen 103 to computer 113. The computer 113 takes in the positions and calculates the distance of the spray can 105 from the screen 103. This distance is then assigned as a brush or spray size for the spray can's digital spray paint that is displayed on the screen 103 when a person presses button 117 on the spray can 105. At 127, the tracker 109 determines whether or not the user has depressed button 117. If computer 113 receives indication at 131 that the spray button 117 has been pressed, as indicated by the spray signal from tracker 109, computer 113 causes wall 103 to display a virtual spray of paint corresponding to the position information. Once the user stops pressing button 117, operation proceeds to 135 for deactivating the virtual spray.

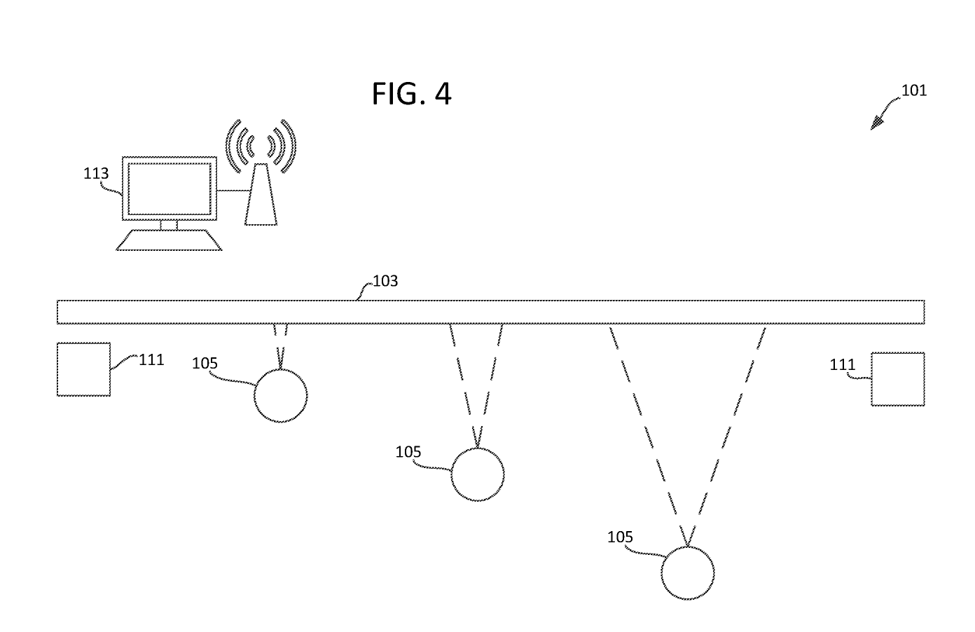

FIG. 4 illustrates the size of the “virtual spray” from the can 105 is determined based on the distance can 105 is from screen 103. The closer the can 105 (including position tracker 109) is to the wall 103, the smaller the spray. The farther the can 105 (including position tracker 109) is away from the wall 103, the larger the spray. In other words, the displays on the LED screen/wall 103 show a progressively larger diameter spray image as the position tracker 109 moves farther from the screen 103.

In an embodiment, system 101 comprises:
a. The 3D-printed spray can 105;
b. Components housed inside the spray can housing 115 that communicate with the position tracker 109, including multiple wires and 2 buttons 117, 119;
c. The position tracker 109 attached to the bottom of the housing 115;
d. Virtual reality base stations, or sensors, 111 that track the movement (positioning and rotation) of the position tracker 109 and, thus, movement of the spray can 105;
e. The computer 113 that analyzes the information and displays it instantly on a display 103; and
f. The display 103, which can be a monitor, such as a large LED screen or LED wall, or a projector that projects onto a screen or wall, or any other imaging output.

The following is exemplary pseudo code embodies aspects of the invention:

Loop

Can_position = Get tracked position of can
Can_rotation = Get tracked rotation of can
Screen_position = Get tracked position of screen
Distance = (Can_position − Screen_position).magnitude
Brush_size = Distance
If(Spray_button_press)

SprayBrushApply(Brush_size)

if(!Spray_button_press)

SprayBrushStop( )

EndLoop
SprayBushApply(Brush_size)

Write brush to screen with size as Brush_size

SprayBrushStop( )

Stop brush writing to screen

The sensor system may be arranged on one or more of: a peripheral device, which may include a user interface device, the HMD; a computer (e.g. a P.C., system controller or like device); other device in communication with the system. One example is a laser-based positional tracking system, referred to as Lighthouse, which operates by flooding a room with non-visible light, where the Lighthouse functions as a reference point for any positional tracking device (e.g., the position tracker 109) to determine where the spray paint can 105 is located in real 3D space.

In addition to the embodiments described above, embodiments of the present disclosure may comprise a special purpose computer including a variety of computer hardware, as described in greater detail below.

Embodiments within the scope of the present disclosure also include computer-readable media for carrying or having computer-executable instructions or data structures stored thereon. Such computer-readable media can be any available media that can be accessed by a special purpose computer and comprises computer storage media and communication media. By way of example, and not limitation, computer storage media include both volatile and nonvolatile, removable and non-removable media implemented in any method or technology for storage of information such as computer readable instructions, data structures, program modules or other data. Computer storage media are non-transitory and include, but are not limited to, random access memory (RAM), read only memory (ROM), electrically erasable programmable ROM (EEPROM), compact disk ROM (CD-ROM), digital versatile disks (DVD), or other optical disk storage, solid state drives (SSDs), magnetic cassettes, magnetic tape, magnetic disk storage, or other magnetic storage devices, or any other medium that can be used to carry or store desired non-transitory information in the form of computer-executable instructions or data structures and that can be accessed by a computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the disclosure may be implemented. Although not required, aspects of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the disclosure includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory computer storage media, including nonvolatile and volatile memory types. A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, SSDs, and the like.

Communication media typically embody computer readable instructions, data structures, program modules or other data in a modulated data signal such as a carrier wave or other transport mechanism and includes any information delivery media.

Program code means comprising one or more program modules may be stored on the hard disk, magnetic disk, optical disk, ROM, and/or RAM, including an operating system, one or more application programs, other program modules, and program data. A user may enter commands and information into the computer through a keyboard, pointing device, or other input device, such as a microphone, joy stick, game pad, satellite dish, scanner, or the like. These and other input devices are often connected to the processing unit through a serial port interface coupled to the system bus. Alternatively, the input devices may be connected by other interfaces, such as a parallel port, a game port, or a universal serial bus (USB). A monitor or another display device is also connected to the system bus via an interface, such as video adapter. In addition to the monitor, personal computers typically include other peripheral output devices (not shown), such as speakers and printers.

One or more aspects of the disclosure may be embodied in computer-executable instructions (i.e., software), routines, or functions stored in system memory or nonvolatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform all operations (e.g., execute computer-executable instructions) in real-time.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

Embodiments may be implemented with computer-executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments may include different computer-executable instructions or components having more or less functionality than illustrated and described herein.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A virtual reality graffiti wall system comprising:
an image display;
a housing simulating a spray paint can;
a position tracker attached to the housing and configured to generate a spray signal responsive to user input and to generate positioning data representative of a position thereof;
a plurality of sensors configured to determine the position of the position tracker relative to the image display based on the positioning data; and
a computing device having a memory device associated therewith, said memory device storing computer-executable instructions that, when executed by the computing device, cause the image display to display an image representative of a virtual spray of paint on the image display corresponding to the determined position in response to the spray signal.

2. The system of claim 1, wherein the positioning data comprises a tracked position of the position tracker relative to a reference point in a spatial environment.

3. The system of claim 1, wherein the positioning data comprises a rotation of the position tracker relative to a reference axis in a spatial environment.

4. The system of claim 1, wherein the spray signal is indicative of size of spray to be displayed on the image display.

5. The system of claim 1, wherein the spray signal is indicative of color of spray to be displayed on the image display.

6. The system of claim 1, wherein the housing includes a condition input sensor for generating a condition input data and wherein the position tracker receives the condition input data and generates the spray signal in response thereto.

7. The system of claim 6, wherein the condition input sensor comprises at least one of a pressure sensor, a button trigger, a touch sensor, and a motion sensor.

8. The system of claim 1, wherein each of the sensors comprises a base station located at a reference point and configured for emitting an optical radiation, and wherein the position tracker comprises an optical sensor array, the optical sensor array configured to detect the optical radiation sent from the base station and generate the positioning data of the position tracker relative to the reference point.

9. A method comprising:
generating a spray signal responsive to user input;
generating positioning data representative of a position of a position tracker, the position tracker attached to a housing simulating a spray paint can;
determining, by a plurality of sensors associated with an image display, the position of the position tracker relative to the image display based on the positioning data; and
displaying, in response to the spray signal, an image representative of a virtual spray of paint on the image display corresponding to the determined position.

10. The method of claim 9, wherein generating positioning data comprises tracking the position of the position tracker relative to a reference point in a spatial environment.

11. The method of claim 9, wherein generating positioning data comprises determining a rotational position of the position tracker relative to a reference axis in a spatial environment.

12. The method of claim 9, wherein the spray signal is indicative of size of spray to be displayed on the image display.

13. The method of claim 9, wherein the spray signal is indicative of color of spray to be displayed on the image display.

14. The method of claim 9, further comprising:
generating, by a condition input sensor, a condition input data;
receiving, by the position tracker, the condition input data; and
generating the spray signal in response to the received condition input data.

15. The method of claim 14, wherein the condition input sensor comprises at least one of a pressure sensor, a button trigger, a touch sensor, and a motion sensor.

16. The method of claim 9, wherein each of the sensors comprises a base station located at a reference point and configured for emitting an optical radiation, and wherein generating positioning data comprises detecting the optical radiation sent from the base station and generating the positioning data of the position tracker relative to the reference point based on the detected optical radiation.

17. A virtual spray paint can comprising:
a cylindrical housing simulating a spray paint can;
a trigger responsive to user input for generating an on/off signal indicative of beginning and ending a spraying operation; and
a position tracker attached to the housing, wherein the position tracker is configured to generate positioning data representative of a position thereof relative to an image display and to generate a spray signal based on the position data and the on/off signal;
wherein a computing device is responsive to the spray signal to cause the image display to display an image representative of a virtual spray of paint on the image display.

18. The virtual spray paint can of claim 17, further comprising a color selector responsive to user input for generating a color selection signal indicative of color of spray to be displayed on the image display, and wherein the position tracker is further configured to generate the spray signal based on the color selection signal.

19. The virtual spray paint can of claim 17, wherein the positioning data comprises at least one of a tracked position of the position tracker relative to a reference point in a spatial environment and a rotation of the position tracker relative to a reference axis in the spatial environment.

20. The virtual spray paint can of claim 17, wherein the housing includes a condition input sensor for generating a condition input data, wherein the position tracker receives the condition input data and generates the spray signal in response thereto, and wherein the condition input sensor comprises at least one of a pressure sensor, a button trigger, a touch sensor, and a motion sensor.
